(19) United States
(12) Patent Application Publication
(10) Pub. No.: US 2003/0098849 A1
(43) Pub. Date: May 29, 2003

(54) Double roller mouse structure

(76) Inventor: Yen Jzuhsiang, Chung Ho City (TW)

Correspondence Address: BACON & THOMAS, PLLC, 625 SLATERS LANE, FOURTH FLOOR, ALEXANDRIA, VA, 22314

(21) Appl. No.: 09/993,484

(22) Filed: Nov. 27, 2001

(51) Int. Cl. G09G 5/08

(52) U.S. Cl. 345/163

(57) ABSTRACT

The present invention relates to a double roller mouse structure for personal computers mainly comprising of a front and left roller wheel. The front roller is situated at the front part of the lower housing of the mouse between the left and the right key button switch and can roll forward, backward or be pressed from above. The left roller is situated at the left part of the lower housing of the mouse and forms a right angle with the front roller wheel and can roll forward, backward or be pressed from above. Hence, with the new design of the present invention, the mouse can be controlled by the thumb, forefinger, middle finger as well as the ring finger and eight kinds of switches can be operated without moving the mouse.

### TECHNICAL RANGE

The present invention relates to a double roller mouse structure mainly used in personal computers.

### INVENTION BACKGROUND

In today's commonly used computers, cursor movement is often controlled using devices such as mice and trackballs. Mice and trackballs both include a housing with two key buttons switch at the front part and a roller ball at the lower part and are moved on a flat surface.

Though commonly used computers have been improved to include a roller at the side or a key button switch and a roller wheel at the front part in order to handle more complicated work, it is still not very practical as dirt or other objects might get in the way and surface is limited.

According to the present invention, the roller wheel has been replaced by other structures in order to carry more complicated work in personal computers used nowadays.

### SUMMARY OF INVENTION

According to the present invention of a double roller mouse structure, a computer input device uses a currently available mouse structure with a left and right key switch button and further includes another roller wheel between the left and right key switch button controlled by the middle finger.

### DESCRIPTION OF DRAWING

FIG. 1 shows a view of the present invention.

FIG. 2 shows a view of internal parts of present invention.

FIG. 3 shows activation of the back roller.

### NUMERICAL

10—mouse

11—lower housing

12—signal cord

13—front roller wheel

14—left roller wheel

15—left key switch button

16—right key switch button

17, 27—direction switch

170, 270—axis hole

18, 28—switch button

19, 29—axis

20—wheel shaft support

21—circuit plate

22—perpendicular stand

23—conducting plate

### MODE FOR CARRYING OUT INVENTION

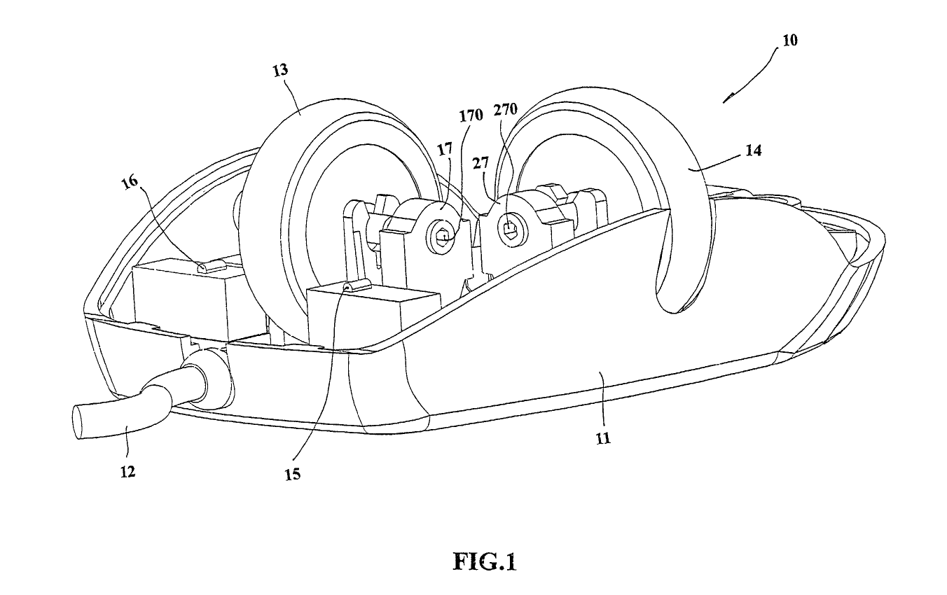

With reference to FIG. 1 showing a view of the present invention, a signal cord 12 is found at the lower housing 11 of mouse 10 and is used to connect to personal computer. The front roller wheel 13 as well as the left roller wheel 14 protrude through the shell body (not shown in diagram) to the side of lower housing 11 and front roller wheel 13 is found between left key switch button 15 and right key switch button 16.

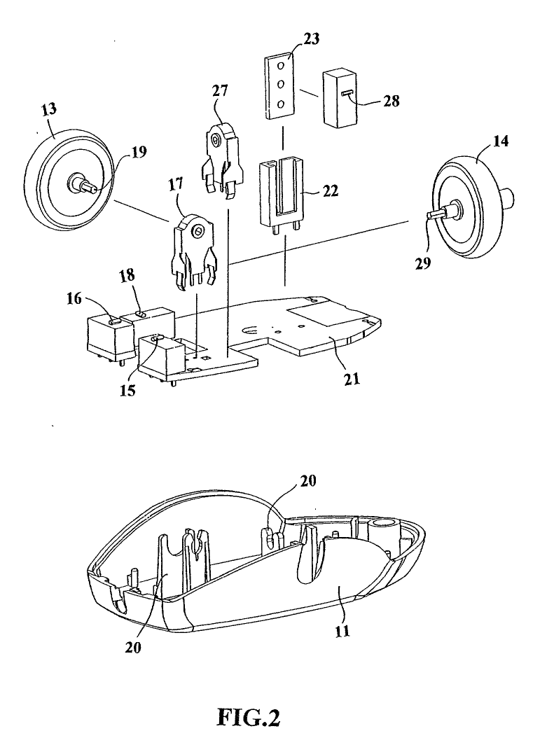

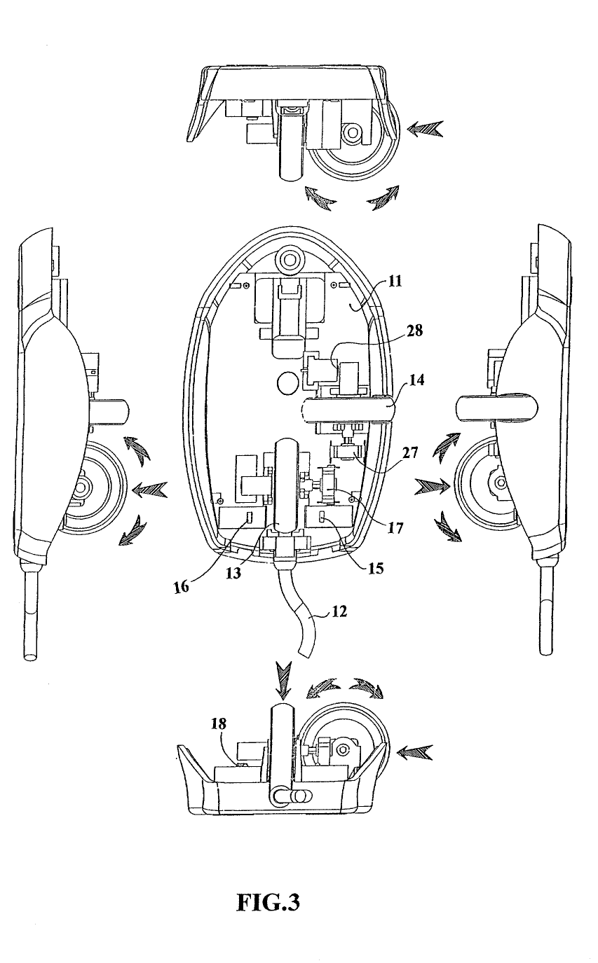

With more reference to FIG. 1, front roller wheel 13 and left roller wheel 14 are designed with a direction switch 17, 27 and a switch button 18, 28 (please refer to FIGS. 2 and 3). Direction switch 17 cause activation of axis 19, 29 and transitions between digital “0” and “1” input signals are detected and direction in which mouse is being moved can thus be determined.

With reference to FIG. 2 showing a view of internal parts of the present invention, the lower housing 11 of mouse 10 is designed with multiple wheel shaft supports 20 and each switch including left key switch button 15, right key switch button 16, switch button 18 of front roller wheel 13, direction switch button 17 of front roller wheel 13, switch button 28 of left roller wheel 14 and direction switch 27 of left roller wheel 14 are designed on the same circuit plate 21.

With reference to FIG. 3 showing activation of the back roller, we can understand that switch button 18 of front roller 13 is used for forward, backward and perpendicular direction and switch button 28 of left roller wheel 14 is used for forward (up), backward (down) and vertical direction without, however, influencing left key switch button 15 and right key switch button 16. The structure of the present invention is fictionally designed with eight controlling switches and can be applied to personal computers without having to slide the mouse, thus obviating the problem of limited space and undesirable objects. Further, use of present invention as described above is mainly for right-handed users, but the same principle can also be applied for left-handed users.

1. A kind of double roller mouse structure mainly consisting of a front and left roller wheel wherein:
Said front roller wheel is situated at the front part of the lower housing of the mouse between the left and right key button switch and can roll forward, backward or be pressed from above;
Said left roller is situated at the left part of the lower housing of the mouse and forms a right angle with front roller wheel and can roll forward (up), backward (down) or be pressed from above.

2. The input device of claim 1 of “A kind of double roller mouse structure”, a signal cord is found at the lower housing of the mouse to connect to personal computer and the front roller wheel as well as the left roller wheel protrude through the shell body to the side of the lower housing.

3. The input device of claim 1 of “A kind of double roller mouse structure”, the front roller wheel and the left roller wheel are designed with a direction switch and switch button. The direction switch causes activation of the axis and direction in which mouse is moved is thus determined.

4. The input device of claim 1, claim 2 or claim 3 of “A kind of double roller mouse structure”, the lower housing of said mouse is designed with multiple wheel shaft supports and each switch including left key switch button, right key switch button, switch button of front roller wheel, direction switch button of front roller wheel, switch button of left roller wheel and direction switch of left roller wheel are designed on the same circuit plate.

5. The input device of claim 1, claim 2, claim 3 or claim 4 of “A kind of double roller mouse structure”, the front roller wheel and the left roller wheel are situated at supporting axis stands and are fixed to each direction switch by means of axis through axis holes. The left key switch button is controlled by the thumb and goes in a vertical direction. A perpendicular stand and a conducting plate is specially designed to position the key switch at the lower housing and circuit plate.
